(19) United States
(12) Patent Application Publication
(10) Pub. No.: US 2015/0282497 A1
(43) Pub. Date: Oct. 8, 2015

(54) PORTION CONTROL FOR INDIVIDUALIZED SERVINGS OF BUTTER AND THE LIKE

(71) Applicant: Clint Arthur, Los Angeles, CA (US)

(72) Inventor: Clint Arthur, Los Angeles, CA (US)

(21) Appl. No.: 14/677,876

(22) Filed: Apr. 2, 2015

Related U.S. Application Data
(60) Provisional application No. 62/056,588, filed on Sep. 28, 2014.
(60) Provisional application No. 61/974,605, filed on Apr. 3, 2014.

(51) Int. Cl. A23C 15/12; A23C 15/18

(52) U.S. Cl. CPC A23C 15/12; A23C 15/18

(57) ABSTRACT

A system and method for efficiently manufacturing, distributing, and serving individual portions of butter and the like while minimizing/eliminating state change. An individual portion sized glass jar has softened, but unmelted, fresh butter installed and then vacuum-sealed. Further distribution, storage, and serving may be done without freezing with a principle effort at preventing melting, such as maintaining the product in a chilled, but not frozen state.

### CROSS REFERENCE TO RELATED APPLICATIONS

This application claims benefit of both U.S. Patent Application No. 61/974,605 filed 3 Apr. 2014 and U.S. Patent Application No. 62/056,588, the entireties of their contents of which are hereby expressly incorporated by reference for all purposes.

### FIELD OF THE INVENTION

The present invention relates generally to portion control of foodstuff, and more specifically, but not exclusively, to individualized servings of high grade butter.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The food industry has many instances of providing individual servings of a foodstuff to a customer. In many cases, the foodstuff is manufactured and distributed in large quantities inappropriate for an individual serving.

In these cases, there is a requirement to convert the foodstuff to an individual serving size. During the conversion, it is preferable that the quality of the foodstuff not be degraded. There are other secondary considerations including improving efficiency and reducing waste which also factor into reducing costs associated with the conversion.

In the specific case of a foodstuff like butter, individual portion control is important for restaurant and in-room dining. There are many times when an individual serving of butter is provided as an accompaniment to a food order. That individual serving is commonly provided as a pat or ball of butter in a small bowl, or as slab of butter disposed between a pair of waxed paper panels. In both cases, shelf life is dependent upon the environment. There are limited systems to offer minor adjustments of the shelf life; such as use of ice or chilled water.

Some systems offer an individual portion of a whipped butter product in a small covered plastic tub. These tubs are opaque and not vacuum-sealed. The customer has no opportunity to see the product before use. The product is still required to be chilled or frozen.

Disadvantages are numerous, and include production of these individual portions in an inefficient manner, sometimes being performed manually by workers, and frequently requires the butter to be melted in order for the butter to be put through the production process machinery. Changing the state of the butter to liquid by raising the temperature to the melting point creates a waxy texture, and changes the color of butter. These are characteristics that are preferably avoided.

A further disadvantage is that the prior art systems are wasteful in that conventional unconsumed individual portions are discarded. Wholesomeness of unconsumed portions cannot be guaranteed once offered to a customer.

For many customers who appreciate high-grade butter, the color, flavor, texture, aroma, and spreadability of the butter with a meal are important considerations. Butter that includes one or more state changes is degraded with each state change of frozen, thawed, and molten to another state.

What is needed is a system and method for efficiently manufacturing, distributing, and serving individual portions of butter and the like while minimizing/eliminating state change.

### BRIEF SUMMARY OF THE INVENTION

Disclosed is a system and method for efficiently manufacturing, distributing, and serving individual portions of butter and the like into vacuum sealed jars without melting the butter.

The following summary of the invention is provided to facilitate an understanding of some of technical features related to portion control for butter, and is not intended to be a full description of the present invention. A full appreciation of the various aspects of the invention can be gained by taking the entire specification, claims, drawings, and abstract as a whole. The present invention is applicable to other foodstuff in addition to butter.

The disclosed system and method allow for fresh butter to be packaged, distributed, and served without ever being frozen or melted, preserving its highest state of quality. The system and method enhances customer enjoyment by, among things, improving spreadability, flavor, and aroma while reducing waste and improving loss prevention to the distributor/retailer.

The apparatus includes fresh butter installed into an individual portion sized transparent (e.g., glass) container and sealed with a closure system that supports a vacuum-seal. These containers may be distributed, stored, and served without a requirement for freezing, ice, or other significant environmental control. In some situations it is preferred to maintain the temperature below the melting point but even in these situations while there is some risk of quality degradation from melting, there is no risk of spoilage.

An individual portion apparatus for butter, including a container including a base and one or more sidewalls extending from the base to an opening, the base and one or more sidewalls defining a cavity accessible through the opening; a quantity of non-denatured solid butter disposed within the cavity; and a closure sealing the opening and configured to provide an airtight seal between the closure and the opening.

A method for manufacturing an individual portion of butter, including a) presenting a container at a filling station, the container including a base and one or more sidewalls extending from the base to an opening, the base and one or more sidewalls defining a cavity accessible through the opening; b) disposing a quantity of softened non-melted butter into the cavity producing a disposed quantity of butter; and c) vacuum-sealing the opening with a closure without denaturing the disposed quantity of butter.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an individual serving of fresh butter;

FIG. 2 illustrates a process for serving a portion of butter;

FIG. 3-4 illustrate a butter portioning machine;

FIG. 3 illustrates a side elevation view of the butter portioning machine;

FIG. 4 illustrates a top plan view of the butter portioning machine;

FIG. 5 illustrates a labeled container for an individual portion of butter; and

FIG. 6 illustrates a set of labels to be applied to the individual containers by the portioning machine.

### DETAILED DESCRIPTION OF THE INVENTION

Embodiments of the present invention provide a system and method for efficiently manufacturing, distributing, and serving individual portions of butter and the like. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “butter” refers to a dairy product resulting from churned cream or milk, principally milk from a cow, but will include in some contexts milk from other mammals such goats, sheep, buffalo, yaks, and the like. Butter for purposes of this invention is an emulsification of butterfat, milk proteins, and water that is a solid when refrigerated, softens to a spreadable consistency at room temperature (nominally at about 73 degrees F. with a range of about 68-79 degrees F.) and melts at an elevated temperature dependent upon several factors, commonly in a range of about 90-95 degrees F.). The US Standard for butter requires a minimum of 80 percent by weight of milkfat. The United States Department of Agriculture, Agricultural Marketing Service, Dairy Division provides a publication, United States Standards for Grades of Butter, effective 31 Aug. 1989, hereby expressly incorporated by reference in its entirety for all purposes. As used herein, high grade refers to a Butter Grade of U.S. Grade AA but other grades may be similarly processed as described herein in some other applications.

The butterfat in butter is itself a mixture of several different fats and thus butter does not “melt” at a sharply defined temperature, and because of several different factors including varying amounts of the different fats, butter softens over a range of temperatures and finally a point is reached where the butter is almost entirely liquid. Butter, being an emulsification, includes a quantity of water that is, at a microscopic level, made up of small drops of water inside of fat envelopes. This emulsification maintains butter in a uniform consistency and inhibits the butter from separating into its constituent layers (e.g., a layer of fat floating on the quantity of water). Melting allows the water to escape from the envelopes and join together. The longer butter is held at an elevated temperature, and the higher the elevated temperature, the greater the degree of separation of the water from the fats. Melting thus includes some measure of liquefaction as well as separation. At some temperature levels, the water evaporates and the ratio of water to butterfat changes. Sometimes this is characterized as a loss of plasticity or a change in a graininess. Commercial butter may have a further attribute of a desired crystalline structure. Manufacturers will control their butter quality and consumer appeal in many ways, such as producing a desired crystallization by controlling rate of cooling and temperature ranges over which butter is manufactured. For purposes of this application, a denaturation of a quantity of non-melted butter refers to a melting of that quantity that results in formation of a visible water-butterfat interface between a layer of water and a layer of butterfat and/or crystallization changes in the butter, from 1-50% or more of the quantity affected. Practically at some point these adverse changes may not be perceptible to the intended consumer, or may be of a character or degree and determined to be so minor that the consumer is not affected to such a degree that the benefits and convenience of the individual portion control are outweighed by the denaturation. Separation may more directly perceived and evaluated than changes in crystalline structure or other mouth-quality or variations between the quantity of butter in a non-melted state as opposed to a re-solidified (from a denaturing melting) state.

Some implementations may provide a much more stringent threshold, not allowing zero-ten percent denaturation, more preferably one-five percent, or other metric appropriate to the target consumer. Without denaturation, the indicated amount of the non-denatured volume substantially retains its pre-melted characteristics, such as ratio of butterfat to water and/or crystalline structure.

When melting occurs within a container, such as a jar, and there is no mechanism to re-emulsify the butterfat and the water under controlled conditions, the layers remain separated and do not automatically become re-emulsified or achieve the desired crystalline structure. If there is then re-solidification, such as lowering the temperature, the solidified, melted butter retains some amount of this separation (the amount dependent upon the degree of melting and separation) and has an altered crystalline structure in regions of the individual portions. Melting thus begins an alteration process that for purposes of some of the disclosed embodiments is undesirable. It is undesirable not only because of the change in the visual element (many consumers prefer uniform, non-separated butter) is noticeable in those embodiments using transparent containers, but the melted and separated butter can be exposed to oxygen which initiates or accelerates a process of rancidification. Preferably no melting occurs in the butter processing in the preparation of individualized portion controls. In some instances, a minor amount of melting may occur.

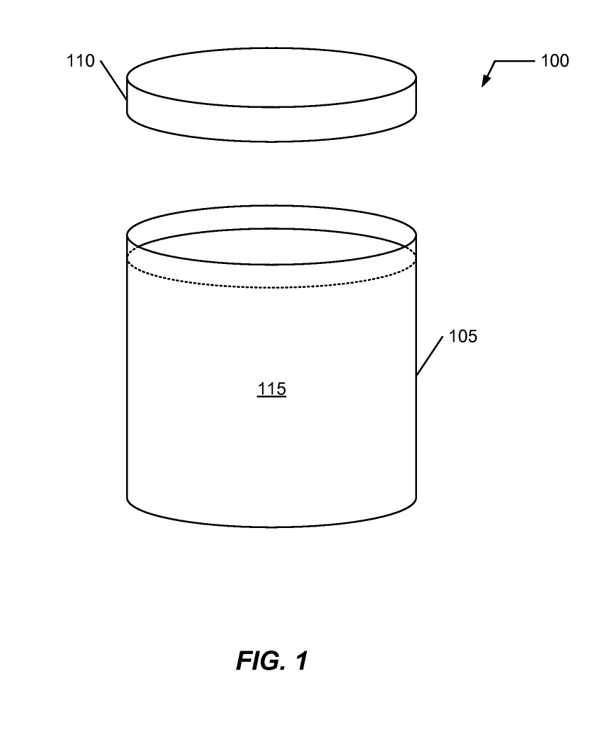

FIG. 1 illustrates an individual serving 100 of fresh butter. Individual serving 100 includes a small transparent glass jar 105, a closure system 110 capable of supporting a vacuum-seal in cooperation with jar 105 to display and serve a quantity of fresh butter 115.

Jar 105 is preferably a 1 ounce serving size but other implementations may include some other size for individual portion, or use at a single meal (e.g., a quantity size for multiple persons at a single meal), or sometimes an even greater quantity. Jar 105 is transparent to allow the customer to visually inspect the quality of fresh butter 115 contained therein; which when prepared and installed as described herein can be a rich and lustrous yellow/golden color which improves the customer's dining experience and good will association with the service providing individual serving 100.

Jar 105 is typically a cylindrical shape having a base, vertical sidewalls, and a top opening opposite of the base. Fresh butter 115 is installed into jar 105 through the top opening and consumed out of jar 105 through the top opening as well.

Closure system 110 is a lid or other covering for the top opening that may attach to jar 105 in a number of ways. One way includes use of threads proximate the top opening and use of complementary structures on closure system 110 to engage the threads and secure closure system over the top opening. Some elastomeric compound or the like may be used with closure system 110 to engage the sidewall of jar 105 proximate the top opening to seal the top opening and support a vacuum seal of fresh butter 115.

Closure system 110 may include a seal-evident mechanism to allow visual or manual manipulation in order to determine whether closure system 110 had been removed or the vacuum seal of fresh butter 115 released.

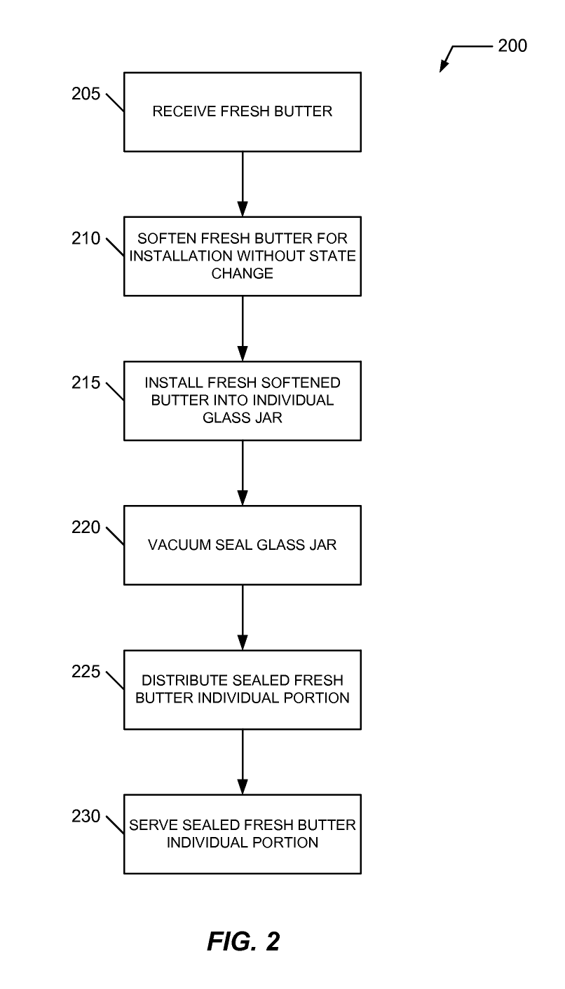

Fresh butter 115 is preferably installed as described herein including the process illustrated in FIG. 2 to maintain a ‘never frozen’ quality. In some implementations, fresh butter 115 is replaced with butter that has been previously frozen before installation and/or frozen after installation. Such alternatives are possible but not preferred. Being vacuum-sealed in jar 105 using closure system 110, fresh butter 115 may be offered to a customer at a warmer temperature than safely offered using conventional systems that is close to but less than a melting temperature (e.g., about 85 degrees Fahrenheit). This warmer temperature improves spreadability and aroma without risk of contamination or quality degradation from elevated non-sealed storage and serving.

Individual serving 100 improves loss prevention and limits waste for a number of reasons including that a sealed but unused individual serving 100 may be served to another customer as freshness is guaranteed.

FIG. 2 illustrates a process 200 for serving a portion of butter. Process 200 includes a set of steps 205-230. Process 200 describes a preferred process in which never-frozen fresh butter is received from a manufacturer, processed, distributed, and served all in the fresh state. While some attributes of butter quality may be subjective, process 200 enables a manufacturer to perform all processing steps with butter in the fresh, unfrozen and unmelted state which at least some manufacturers, distributors, retailers, and customers believes provides the highest quality and greatest experience. Some implementations may include a one or more freezing, thawing, melting, and/or hardening processes in addition to or in lieu of some of those shown here.

Process 200 begins with receipt of a large quantity of fresh butter from a dairy or other butter manufacturer. After receipt the fresh butter is maintained in its fresh state (neither frozen or melted) until step 210 where it is softened in preparation for installation into an individual portion sized container, e.g., jar 105 illustrated in FIG. 1. The softening maintains the fresh butter in the fresh condition while allowing it to be mechanically installed into the individual portion sized container at step 215. The softened fresh butter is installed to completely fill the container during step 215 or as full as necessary/required that is appropriate for the subsequent vacuum-sealing process of step 220.

Step 220 seals and protects fresh butter within the individual portion sized container. There are many different types of sealing implementations that could be used, step 220 includes preferably includes those processes that preserve the freshness of the fresh butter (e.g., do not provide too great or sustained of a heating sequence that at most no more than an incidental amount of fresh butter is raised above a melting temperature). In the illustrated implementation, the fresh butter is softened and never melts or otherwise becomes liquid in the filling or sealing processes.

The vacuum-sealed individual portion sized containers with the fresh butter installed is next distributed. Because the fresh butter is installed into a vacuum-sealed container, the container is not required to be frozen and may be shipped chilled to preserve the butter in the never-frozen state at step 225.

The individual portion sized containers may be delivered to restaurants, hotels, bed & breakfasts, and other service providers who have occasion to serve foodstuff including individual portions of butter to a customer. At step 230, these service providers may then serve one or more of the individual portions of fresh butter, such as individual serving 100, to their customers efficiently without waste and unnecessary loss.

The customer is able to visually inspect the container and see the color of the fresh butter to confirm and enjoy its quality even before unsealing jar 105. When unsealing jar 105, the customer is able to enjoy the aroma of fresh butter because it may be served near, but preferably below, its melting point. This temperature also improves the flavor and spreadability/consumption of the fresh butter and further improves the customer's enjoyment of the meal and the fresh butter.

Automated filling and sealing machinery may be adapted for the present invention. In some embodiments, the processing disclosed in FIG. 2, particularly steps 210-220, is performed without any melting of the butter. Butter is softened to an injectable solid consistency (temperature will vary based upon milk composition and is anticipated to be in the range of about 75-80 degrees Fahrenheit, sometimes a range that is not higher than 80 degrees Fahrenheit) and always below its denaturing melting point. The softened injectable butter is injected into individual serving containers (e.g., jars) having never been melted or denatured. The filled jar is placed into a vacuum chamber to remove oxygen/air (some other implementations may remove the oxygen with other methods (e.g., flushing or the like), the container closure tightened and then the container and container closure are vacuum-sealed without elevating the temperature.

The process may be performed on an automated filling and sealing system that cleans the containers and prepares them for filling. A filling station prepares and/or maintains a reservoir of the butter at the non-melted injectable consistency. A filling system transfers a predetermined quantity of the injectable butter from the reservoir into each container. A container closure is placed over an opening of the container. The filled container with container closure is placed into a sealing chamber that first displaces the oxygen/air and then vacuum-seals the container closure to the container, again without melting any of the butter in the container. A suitable apparatus may be adapted as suggested and disclosed herein from equipment available from Shanghai Yanban Machinery Com. Ltd., a manufacturer in Shanghai, China.

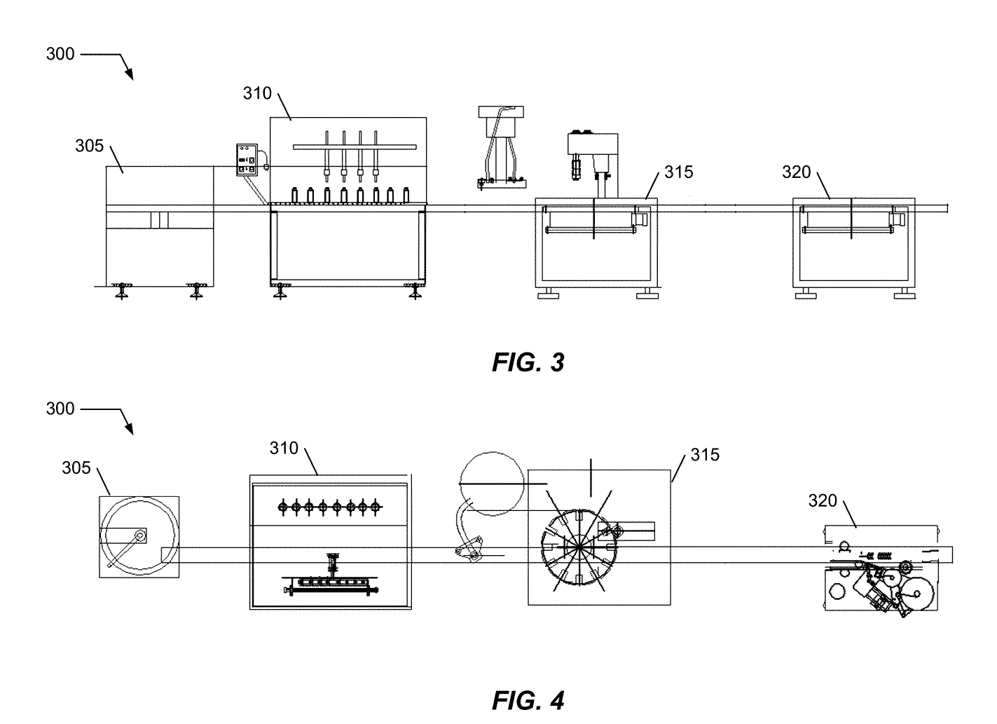

FIG. 3 illustrates a side elevation view of a butter portioning machine 300 and FIG. 4 illustrates a top plan view of butter portioning machine 300. Machine 300 is a main machine in a production line for processing a series of jars (e.g., wide-mouthed closed glass cylinders having an opening approximately equal to a diameter of the jar) of the desired quantity (e.g., 1 ounce). Machine 300 includes a bottle feeder 305, a four-nozzle filling station 310, a vacuum sealing station 315, and a labeling station 320. Bottle feeder 305 includes a reservoir of empty jars and selects and directs them onto the processing sequence. Filling station 310 is adapted to receive a large quantity of softened and injectable solid butter (not liquid or melted), the quantity sufficient for filling many jars without refilling (some embodiments include a control for setting a quality of the softening). Filling station 310 automatically fills each jar in series with the desired quantity of butter. For vacuum sealing as used herein, each jar may be filled fully to produce a better consumer experience as the contents are visible when using a transparent container). A stainless piston measuring pump accurately fills and rolls a screw cap/lid. A nozzle number appropriate to filling with softened butter into each jar is used. Preferably no melting occurs during the sealing (e.g., vacuum sealing) which may optionally include in some embodiments an evacuation of oxygen and/or replacement with an inert gas like nitrogen or the like.

Sealing station 315 applies and vacuum seals a lid onto the opening of each filled jar. Labeling station 320 applies a desired labelling solution to apply one or more labels to each jar. Different implementations may dispose labeling solution 320 before or after filling station 310 and before or after sealing station 315.

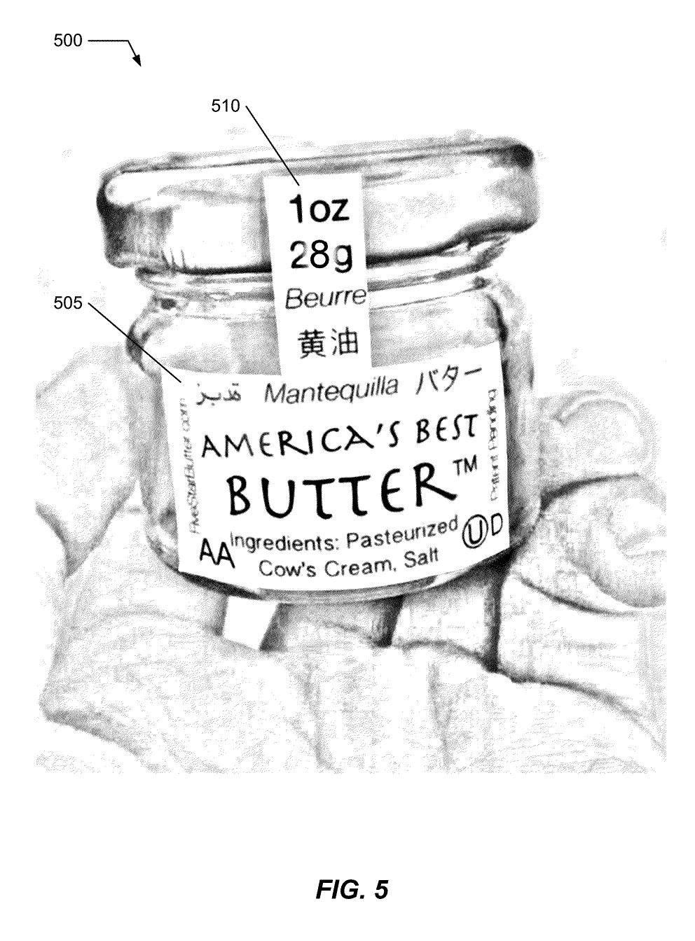

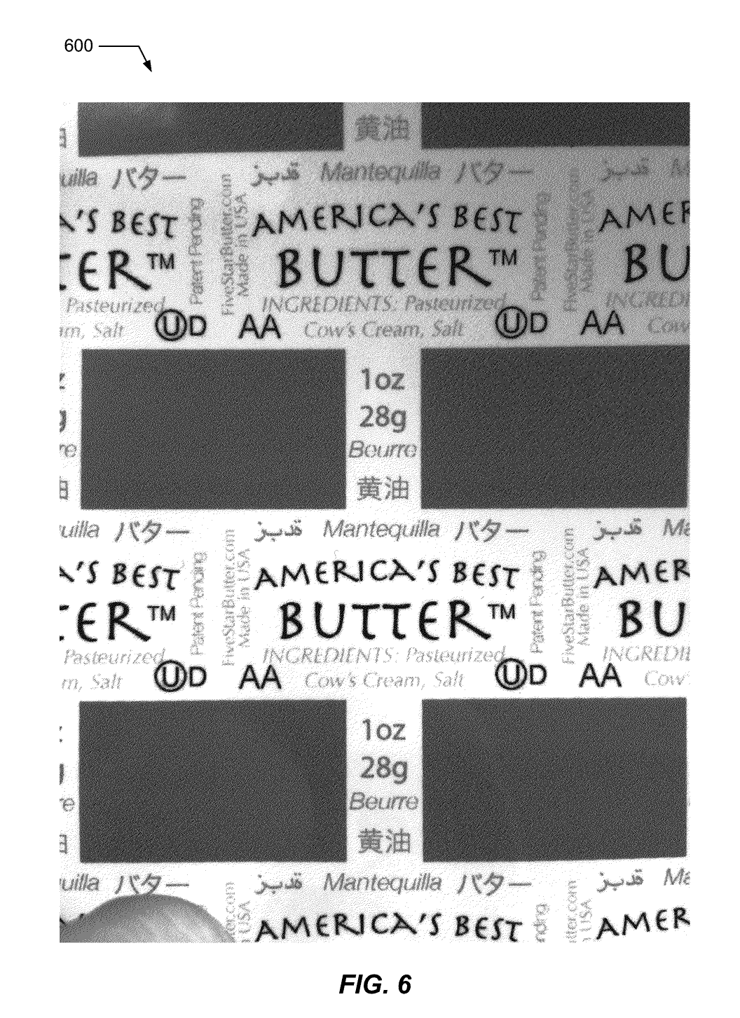

FIG. 5 illustrates a labeled container 500 for an individual portion of butter such as what may be produced by butter portioning machine 300, and FIG. 6 illustrates a set of labels 600 to be applied to the individual containers by portioning machine 300. Labeled container 500 includes a single label 505 that provides a pair of functions: information and an additional tamper evident indicator 510. Indicator 510 is an additional indicator in that the vacuum sealing provides a primary mechanism for tamper evidence by virtue of a broken vacuum seal indicating that labeled jar 500 had previously been opened.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An individual portion apparatus for butter, comprising:
a container including a base and one or more sidewalls extending from said base to an opening, said base and one or more sidewalls defining a cavity accessible through said opening;
a quantity of non-denatured solid butter disposed within said cavity; and
a closure sealing said opening and configured to provide an airtight seal between said closure and said opening.

2. The individual portion apparatus of claim 1 wherein at least one of said sidewalls includes a transparent portion.

3. The individual portion apparatus of claim 1, wherein said cavity includes a quantity of cavity gas having an oxygen content less than standard atmosphere by percentage oxygen

4. The individual portion apparatus of claim 3 wherein said closure is further configured to inhibit an ingress of oxygen from ambient into said cavity.

5. The individual portion apparatus of claim 1 wherein said cavity includes a quantity of cavity gas at a cavity pressure less than standard ambient pressure.

6. The individual portion apparatus of claim 3 wherein said cavity includes a quantity of cavity gas at a cavity pressure less than standard ambient pressure.

7. The individual portion apparatus of claim 6 wherein said closure is further configured to inhibit an ingress of oxygen from ambient into said cavity.

8. A method for manufacturing an individual portion of butter, comprising:
a) presenting a container at a filling station, said container including a base and one or more sidewalls extending from said base to an opening, said base and one or more sidewalls defining a cavity accessible through said opening;
b) disposing a quantity of softened non-melted butter into said cavity producing a disposed quantity of butter; and
c) vacuum-sealing said opening with a closure without denaturing said disposed quantity of butter.

9. The method of claim 8 wherein at least one of said sidewalls includes a transparent portion.

10. The method of claim 8 wherein said vacuum-sealing step c) includes producing a cavity gas within said cavity wherein said cavity gas includes a cavity percentage of oxygen less than an atmosphere percentage of oxygen in a standard atmosphere.

11. The method of claim 10 wherein said vacuum-sealing step c) includes adding a seal to inhibit an ingress of oxygen from ambient into said cavity.

12. The method of claim 8 wherein said vacuum-sealing step c) includes producing a cavity gas within said cavity at a cavity pressure less than an ambient pressure of ambient atmosphere.

13. The method of claim 12 wherein said vacuum-sealing step c) includes adding a seal to inhibit an ingress of ambient atmosphere from ambient into said cavity.

14. The method of claim 8 wherein said vacuum-sealing step c) includes producing a sealed quantity of butter having a denaturation percentage less than a predetermined threshold.

15. The method of claim 14 wherein said predetermined threshold is within a range of 0-20 percent.

16. The method of claim 15 wherein said predetermined threshold is within a range of 1-10 percent.

17. The method of claim 14 wherein said softened non-melted butter includes an installation set of butter quality factors, wherein said sealed quantity of butter includes a sealed set of butter quality factors, and wherein said sealed set of butter quality factors do not vary from said installation set of butter quality factors by more than a predetermined value.

18. The method of claim 17 wherein said predetermined value is within a range of 0-20 percent.

19. The method of claim 17 wherein said sets of butter quality factors include one or more of a ratio of butterfat-to-water, a butter crystalline structure, emulsification percentage, and combinations thereof.
